(19) United States
(12) Patent Application Publication
(10) Pub. No.: US 2017/0149148 A1
(43) Pub. Date: May 25, 2017

(54) DIRECT DRIVE VERY HIGH FREQUENCY OMNI DIRECTIONAL RADIO RANGE (VOR) ANTENNA

(71) Applicant: THALES DEFENSE & SECURITY, INC., Clarksburg, MD (US)

(72) Inventor: Richard MULLIN, Shawnee, KS (US)

(21) Appl. No.: 15/354,517

(22) Filed: Nov. 17, 2016

Related U.S. Application Data
(60) Provisional application No. 62/259,962, filed on Nov. 25, 2015.

(51) Int. Cl. H01Q 25/00; H01Q 7/00

(52) U.S. Cl. CPC H01Q 25/002; H01Q 7/00

(57) ABSTRACT

A method, system, and computer-readable medium for producing a VOR signal in space. Aspects include generating, using a transmitter, a plurality of signals. In addition, determination of an amplitude and phase for each of the plurality of signals is made using the transmitter. Furthermore, each loop antenna in the loop antenna array is driven using one of the plurality of generated signals directly using the transmitter without a radio frequency (RF) bridge, such that an omidirectional reference signal and a spinning variable signal are transmitted from the loop antenna array.

### CROSS-REFERENCE TO RELATED APPLICATION(S)

This application claims the benefit of U.S. Provisional Application Ser. No. 62/259,962 entitled “DIRECT DRIVE VERY HIGH FREQUENCY OMNI DIRECTIONAL RADIO RANGE (VOR) ANTENNA” and filed on November 25, 2015, which is expressly incorporated by reference herein in its entirety.

### BACKGROUND

Field

The disclosure relates generally to the field of navigation aid equipment, and more specifically to methods, systems, and computer-readable media for providing a direct drive of a VOR antenna without the need for a radio frequency (RF) bridge. Other ground based navigation equipment's also have a distribution network to allow the transmitter signals to properly drive the antenna array. This disclosure describes the VOR application. The same teaching is applicable to Instrument Landing and Distance Measuring Equipment (DME) systems.

Background

VORs are part of a short-range radio navigation system that enable aircraft to determine position by receiving radio signals transmitted by a network of fixed ground radio beacons. The radio signals transmitted by VOR antennas have frequencies in the very high frequency (VHF) band from 108 to 117.95 MHz.

A VOR antenna sends out an omnidirectional reference signal, and a directional variable signal that is propagated by a phased antenna array and is perceived to rotate clockwise in space, for example, 30 times a second. The variable signal is timed so that the signal phase (e.g., compared to the reference signal phase) varies as the variable signal rotates, and the phase difference is the same as the angular direction of the spinning variable signal. For example, when the variable signal is being sent 90° clockwise from north, the variable signal is 90° out of phase with the reference signal. By comparing the phase of the variable signal with the reference signal, the angle (e.g., bearing) to the aircraft from the station may be determined. This line of position is referred to as the “radial” from the VOR ground station. The intersection of radials from two different VOR ground stations can be used to determine the position of the aircraft.

Each VOR ground station broadcasts a VHF radio composite signal, including a navigation signal, an identifier signal, and a voice signal, if so equipped. The navigation signal allows the aircraft receiving equipment to determine a bearing from the VOR ground station to the aircraft (e.g., direction from the VOR station in relation to Magnetic North). The identifier signal is typically a three-letter string in Morse code. The voice signal, if used, is usually the station name, in-flight recorded advisories, or live flight service broadcasts.

Conventional VOR antenna systems generate signals by providing a carrier signal and two double sideband (e.g. suppressed carrier) signals from a transmitter. These three signal are sent to a network of RF bridges that combines the carrier signal with the sideband signals and produce four output signals to drive the four antennas that are in the four array. The RF bridges split the carrier signal into two signals, one of which is combined with a first sideband signal. The other carrier signal is combined with the variable sideband signal by the RF bridges.

For example, the RF bridge is used to combine the carrier signal and sideband signal, with one of the sideband signals being 180° (RF degrees) out of phase with respect to the other side band signal. The two sideband signals are both modulated with a 30 Hz sine wave.

Conventionally, one sideband signal represents a 30 Hz audio phase of the −45°. The other sideband signal represents +45°. When the RF phase is shifted 180° (e.g., as in the RF bridge described above), the audio phases become −225° and +225°. The 4 antennas are positioned to be at magnetic azimuth positions of +45°, −225°, +225°, and −45°. The outputs of the RF bridge network are sent to the respective antennas.

However, the use of RF bridges causes several problems for the VOR antenna systems. For example, RF bridges cause a power loss of the antenna system, the tuning process for the RF bridges is a time consuming processes and involves cutting RF cables to an exact length, and the RF bridges need to be retuned for each frequency associated with each antenna.

Therefore, there exists an unmet need in the art for methods, systems, and computer-readable media for a antenna system that does not require an RF bridge to generate the omnidirectional reference signal and the spinning variable signal.

### SUMMARY

A method, system, and implementation for producing a VOR signal in space. Aspects include generating, using a transmitter, a plurality of signals. In addition, determination of an amplitude and phase for each of the plurality of signals is made using the transmitter. Furthermore, each antenna in the antenna array is driven using one of the plurality of generated signals, which directly uses the transmitter without a radio frequency (RF) bridge, such that an omidirectional reference signal and a spinning variable signal are transmitted from the antenna array.

Additional advantages and novel features of these aspects will be set forth in part in the description that follows, and in part will become more apparent to those skilled in the art upon examination of the following or upon learning by practice of the disclosure.

### BRIEF DESCRIPTION OF THE DRAWINGS

FIG. 1 is a diagram illustrating an example aspect of a VOR ground system in communication with aircraft in accordance with aspects of the present disclosure.

FIG. 2 is a diagram illustrating an example aspect of a VOR antenna system in accordance with aspects of the present disclosure.

FIG. 3 is a flowchart of a method for driving an antenna array in accordance with aspects of the present disclosure.

FIG. 4 is a diagram illustrating example aspects of a hardware implementation for a system employing a processing system in accordance with aspects of the present disclosure.

FIG. 5 a system diagram illustrating various example hardware components and other features, for use in accordance with aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in representative diagram form in order to avoid obscuring such concepts.

Several aspects of a direct drive VOR antenna will now be presented with reference to various methods, apparatuses, and media. These methods, apparatuses, and media will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall implementation.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to include instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, firmware, or any combination thereof. If implemented in software, the functions may be stored on or encoded as one or more instructions or code on a computer-readable medium or media. Computer-readable media includes computer storage media. Storage media may be any available media that is able to be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that may be used to carry or store desired program code in the form of instructions or data structures and that may be accessed by a computer. Disk and disc, as used herein, include CD, laser disc, optical disc, digital versatile disc (DVD), and floppy disk, where disks usually reproduce data magnetically, while discs reproduce data optically with lasers. Combinations of the above should also be included within the scope of computer-readable media.

Aspects of the method, system, and medium presented herein may be compatible with various VOR antennas or Alford loop and/or slot antennas that may be used in aircraft navigation systems, for example. In order to reduce or eliminate the need for retuning an RF bridge coupled to the antenna, the system of the present disclosure may generate, directly from the transmitter, signals that are sent to each of the antennas in the system for transmission from the ground beacon.

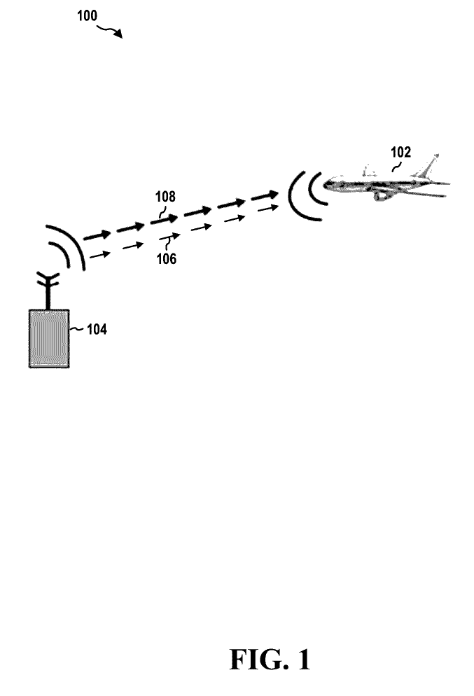

FIG. 1 illustrates an overall system diagram of an example VOR navigation system 100 for use in accordance with aspects of the present disclosure. The example system of FIG. 1 includes, for example, an aircraft 102 and a ground station 104 that includes a VOR loop antenna or an Alfred loop and/or slot antenna. The ground station 104 may send to the aircraft 102 an omnidirectional reference signal 106 and a directional variable signal 108 that is propagated by a phased antenna array and rotates clockwise in space. The directional variable signal 108 may be timed so that the signal phase (e.g., compared to the omnidirectional reference signal 106 phase) varies as the variable signal rotates, and the phase difference is the approximately the same as the angular direction of the direction variable signal 108, which is spinning For example, when the directional variable signal 104 is being sent 90 degrees clockwise from north, the variable signal is about 90 degrees out of phase with the omnidirectional reference signal 106. By comparing the phase of the directional variable signal 108 with the omnidirectional reference signal 106, the angle (e.g., bearing) to the aircraft 102 from the ground station 104 may be determined. This line of position is referred to as the “radial” from the VOR ground station 104. The intersection of radials from two different ground stations may be used to determine the position of the aircraft 102. Further details regarding VOR systems are described in U.S. Pat. No. 3,613,099, titled “VOR ANTENNA SYSTEM,” which issued on Oct. 12, 1971, the entire contents of which are incorporated herein by reference.

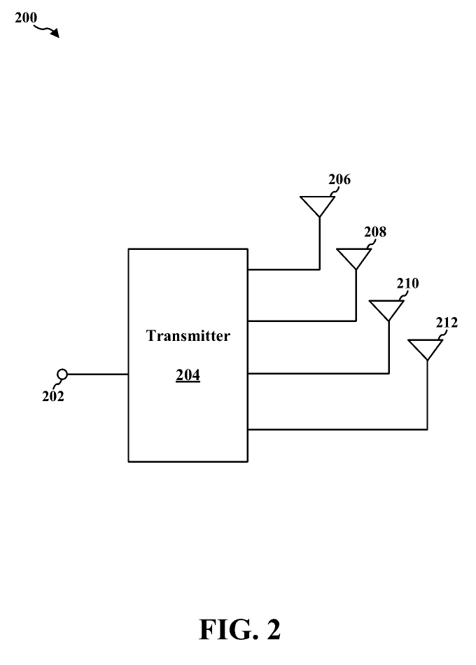

FIG. 2 is an overall system diagram of an example direct drive antenna system 200 for use in accordance with aspects of the present disclosure. The example direct drive antenna system of FIG. 2 may include, for example, four antennas 206, 208, 210, 212. In addition, the system of FIG. 2 includes an input terminal 202 that may supply energy to a transmitter 204. The transmitter 204 may be able to directly generate a plurality of signals from the energy being supplied through the input terminal 202, without the need for an RF bridge. Each one of the generated signals may be intended for a particular one of the four antennas 206, 208, 210, 212. In addition, the transmitter 204 may be able to determine an amplitude and/or phase for each of the plurality of signals. For example, each of the four antennas 206, 208, 210, 212 may require a signal of a particular amplitude and/or phase, and the transmitter 204 may be able to determine these signal parameters for each of the four antennas 206, 208, 210, 212 using one more components in the transmitter 204. The transmitter 204 may send a specific signal to each one of the four antennas 206, 208, 210, 212.

By having a transmitter directly generate the signals for each loop in the antenna, the present system is able to eliminate the need for RF bridge(s) to be included in the system 200. In addition, the interface between the transmitter 204 and each of the four loops is broad band, and the need to retune an RF bridge for each frequency associated with the four loops is eliminated. In addition, the output power of transmitter 204 is much less (e.g., 75% less) than a conventional transmitter that includes RF bridge(s).

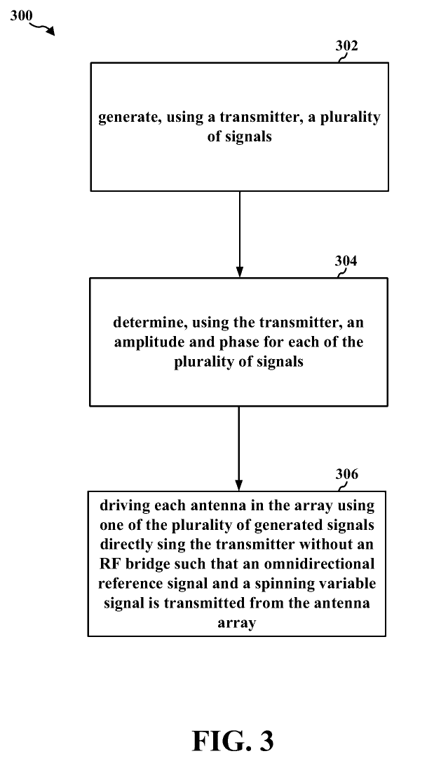

FIG. 3 is flowchart 300 of an example method of driving a loop antenna with an RF bridge. The method may be performed by a VOR antenna system, such as illustrated in FIG. 2, which includes, for example, input terminal 202, transmitter 204, and antennas 206, 208, 210, 212.

In 302, the VOR antenna system is able to generate, using a transmitter, a plurality of signals. For example, referring to FIG. 2, the transmitter 204 may be able to directly generate a plurality of signals from the energy being supplied through the input terminal 202. Each one of the generated signals may be intended for a particular one of the four antennas 206, 208, 210, 212. In addition, the transmitter 204 may be able to determine an amplitude and/or phase for each of the plurality of signals. For example, each of the four loops may require a signal of a particular amplitude and/or phase, and the transmitter 204 may be able to determine these signal parameters for each of the four antennas 206, 208, 210, 212 using one more components in the transmitter. The transmitter 204 may a send specific signal to each one of the four antennas 206, 208, 210, 212.

In 304, the VOR antenna system is able to determine, using the transmitter, an amplitude and phase for each of the plurality of signals. For example, referring to FIG. 2, the transmitter 204 may be able to determine an amplitude and/or phase for each of the plurality of signals. For example, each of the four loops may require a signal of a particular amplitude and/or phase, and the transmitter 204 may be able to determine these signal parameters for each of the four antennas 206, 208, 210, 212 using one more components in the transmitter. The transmitter 204 may a send specific signal to each one of the four antennas 206, 208, 210, 212.

In 306, the VOR antenna system is able drive each loop antenna in the loop antenna array using one of the plurality of generated signals directly using the transmitter without a RF bridge such that an omidirectional reference signal and a spinning variable signal is transmitted from the loop antenna array. For example, referring to FIG. 2, the transmitter 204 may a send specific signal to each of the four antennas 206, 208, 210, 212, such that an omidirectional reference signal and a spinning variable signal are transmitted from the antenna array without using an RF bridge.

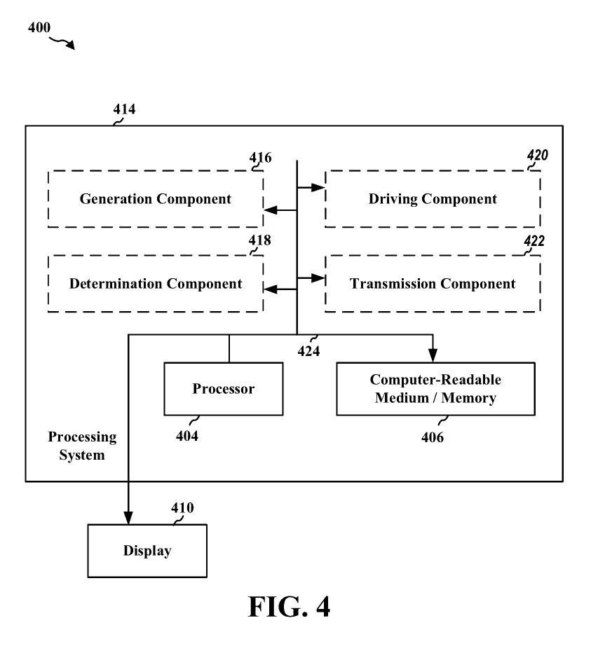

FIG. 4 is a representative diagram illustrating an example hardware implementation for a system 400 employing a processing system 414. The processing system 414 may be implemented with an architecture that links together various circuits, including, for example, one or more processors and/or components, represented by the processor 404, the components 416, 418, 420, 422, and the computer-readable medium/memory 406.

The processing system 414 may be coupled to a transmitter 204 of a loop antenna system 200.

The processing system 414 may include a processor 404 coupled to a computer-readable medium/memory 406 via bus 424. The processor 404 may be responsible for general processing, including the execution of software stored on the computer-readable medium/memory 406. The software, when executed by the processor 404, may cause the processing system 414 to perform various functions described supra for any particular apparatus and/or system. The computer-readable medium/memory 406 may also be used for storing data that is manipulated by the processor 404 when executing software. The processing system may further include at least one of the components 416, 418, 420, 422. The components may comprise software components running in the processor 404, resident/stored in the computer readable medium/memory 406, one or more hardware components coupled to the processor 404, or some combination thereof. The processing system 414 may comprise a component of a loop antenna system 200, as illustrated in FIG. 2.

The system 400 may further include features for generating, using a transmitter, a plurality of signals, features for determining, using the transmitter, an amplitude and phase for each of the plurality of signals, and features for driving a loop antenna using the plurality of generated signals directly using the transmitter without an RF bridge.

The aforementioned features may be carried out via one or more of the aforementioned components of the system 400 and/or the processing system 414 of the system 300 configured to perform the functions recited by the aforementioned features.

Thus, aspects may include a system for driving an antenna system without the need for an RF bridge, e.g., in connection with FIG. 3.

The system may include additional components that perform each of the functions of the method of the aforementioned flowchart of FIG. 3, or other algorithm. As such, each block in the aforementioned flowchart of FIG. 3 may be performed by a component, and the system may include one or more of those components. The components may include one or more hardware components specifically configured to carry out the stated processes/algorithm, implemented by a processor configured to perform the stated processes/algorithm, stored within a computer-readable medium for implementation by a processor, or some combination thereof.

Thus, aspects may include a non-transitory computer-readable medium for driving a loop antenna system without using an RF bridge, the non-transitory computer-readable medium having control logic stored therein for causing a computer to perform the aspects described in connection with, e.g., FIG. 3.

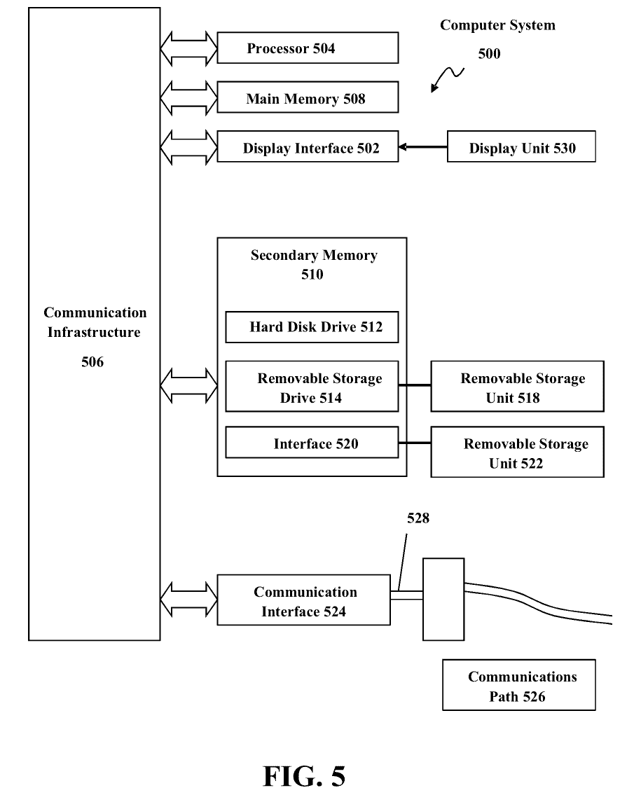

FIG. 5 is an example system diagram of various hardware components and other features, for use in accordance with aspects presented herein. The aspects may be implemented using hardware, software, or a combination thereof and may be implemented in one or more computer systems or other processing systems. In one example, the aspects may include one or more computer systems capable of carrying out the functionality described herein, e.g., in connection with FIG. 2. An example of such a computer system 300 is shown in FIG. 3.

In FIG. 5, computer system 500 includes one or more processors, such as processor 504. The processor 504 is connected to a communication infrastructure 506 (e.g., a communications bus, cross-over bar, or network). Various software aspects are described in terms of this example computer system. After reading this description, it will become apparent to a person skilled in the relevant art(s) how to implement the aspects presented herein using other computer systems and/or architectures.

Computer system 500 can include a display interface 502 that forwards graphics, text, and other data from the communication infrastructure 506 (or from a frame buffer not shown) for display on a display unit 530. Computer system 500 also includes a main memory 508, preferably random access memory (RAM), and may also include a secondary memory 510. The secondary memory 510 may include, for example, a hard disk drive 512 and/or a removable storage drive 514, representing a floppy disk drive, a magnetic tape drive, an optical disk drive, etc. The removable storage drive 514 reads from and/or writes to a removable storage unit 518 in a well-known manner. Removable storage unit 518, represents a floppy disk, magnetic tape, optical disk, etc., which is read by and written to removable storage drive 514. As will be appreciated, the removable storage unit 518 includes a computer usable storage medium having stored therein computer software and/or data.

In alternative aspects, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as that found in video game devices), a removable memory chip (such as an erasable programmable read only memory (EPROM), or programmable read only memory (PROM)) and associated socket, and other removable storage units 522 and interfaces 520, which allow software and data to be transferred from the removable storage unit 522 to computer system 500.

Computer system 500 may also include a communications interface 524. Communications interface 524 allows software and data to be transferred between computer system 500 and external devices. Examples of communications interface 524 may include a modem, a network interface (such as an Ethernet card), a communications port, a Personal Computer Memory Card International Association (PCMCIA) slot and card, etc. Software and data transferred via communications interface 524 are in the form of signals 528, which may be electronic, electromagnetic, optical or other signals capable of being received by communications interface 524. These signals 528 are provided to communications interface 524 via a communications path (e.g., channel) 526. This path 526 carries signals 528 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 580, a hard disk installed in hard disk drive 512, and signals 528. These computer program products provide software to the computer system 500. Aspects presented herein may include such computer program products.

Computer programs (also referred to as computer control logic) are stored in main memory 508 and/or secondary memory 510. Computer programs may also be received via communications interface 524. Such computer programs, when executed, enable the computer system 500 to perform the features presented herein, as discussed herein. In particular, the computer programs, when executed, enable the processor 510 to perform the features presented herein. Accordingly, such computer programs represent controllers of the computer system 500.

In aspects implemented using software, the software may be stored in a computer program product and loaded into computer system 500 using removable storage drive 514, hard drive 512, or communications interface 520. The control logic (software), when executed by the processor 504, causes the processor 504 to perform the functions as described herein. In another example, aspects may be implemented primarily in hardware using, for example, hardware components, such as application specific integrated circuits (ASICs). Implementation of the hardware state machine so as to perform the functions described herein will be apparent to persons skilled in the relevant art(s).

In yet another example, aspects presented herein may be implemented using a combination of both hardware and software.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of the processes/flowcharts disclosed is an illustration of example approaches. Based upon design preferences, it is understood that the specific order or hierarchy in the processes/flowcharts may be rearranged. Further, some features/steps may be combined or omitted. The accompanying method claims present elements of the various features/steps in a sample order, and are not meant to be limited to the specific order or hierarchy presented.

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

1. A method of driving an antenna array, the method comprising:
generating, using a transmitter, a plurality of signals;
determining, using the transmitter, an amplitude and phase for each of the plurality of signals; and
driving each loop antenna in the loop antenna array using one of the plurality of generated signals directly using the transmitter without a radio frequency (RF) bridge, such that an omidirectional reference signal and a spinning variable signal are transmitted from the loop antenna array.

2. The method of claim 1, wherein the antenna array includes an Instrument Landing System Glideslope antenna array.

3. The method of claim 1, wherein the antenna array includes an Instrument Landing System Localizer antenna array.

4. The method of claim 1, wherein the antenna array comprises a distance measuring equipment antenna array.

5. A system for driving an antenna array, the system comprising:
means for generating, using a transmitter, a plurality of signals;
means for determining, using the transmitter, an amplitude and phase for each of the plurality of signals; and
means for driving each loop antenna in the loop antenna array using one of the plurality of generated signals directly using the transmitter without a radio frequency (RF) bridge, such that an omidirectional reference signal and a spinning variable signal are transmitted from the loop antenna array.

6. The system of claim 5, wherein the antenna array includes an Instrument Landing System Glideslope antenna array.

7. The system of claim 5, wherein the antenna array includes an Instrument Landing System Localizer antenna array.

8. The system of claim 5, wherein the antenna array comprises a distance measuring equipment antenna array.

9. A system for driving an antenna array, the system comprising:
a memory; and
a processing system coupled to the memory, the processor and memory being cooperatively configured to:
monitor performance of the navigation aid equipment;
determine if the performance includes any improper performance of the navigation aid equipment; and
remove a signal from an antenna of the navigation aid equipment when any improper performance of the navigation aid equipment is determined.

10. The system of claim 9, wherein the antenna array includes an Instrument Landing System Glideslope antenna array.

11. The system of claim 9, wherein the antenna array includes an Instrument Landing System Localizer antenna array.

12. The system of claim 9, wherein the antenna array comprises a distance measuring equipment antenna array.

13. A computer-readable medium storing computer executable code for driving an antenna array, comprising code for:
generating, using a transmitter, a plurality of signals;
determining, using the transmitter, an amplitude and phase for each of the plurality of signals; and
driving each loop antenna in the loop antenna array using one of the plurality of generated signals directly using the transmitter without a radio frequency (RF) bridge, such that an omidirectional reference signal and a spinning variable signal are transmitted from the loop antenna array.

14. The computer-readable medium of claim 13, wherein the antenna array includes an Instrument Landing System Glideslope antenna array.

15. The computer-readable medium of claim 13, wherein the antenna array includes an Instrument Landing System Localizer antenna array.

16. The computer-readable medium of claim 13, wherein the antenna array comprises a distance measuring equipment antenna array.
